(19) United States
(12) Patent Application Publication
(10) Pub. No.: US 2014/0154574 A1
(43) Pub. Date: Jun. 5, 2014

(54) NEGATIVE ELECTRODE ACTIVE SUBSTANCE AND LITHIUM BATTERY

(71) Applicant: Kunihiro NOBUHARA, Susono-shi (JP)

(72) Inventor: Kunihiro NOBUHARA, Susono-shi (JP)

(73) Assignee: TOYOTA JIDOSHA KABUSHIKI KAISHA, Toyota-shi (JP)

(21) Appl. No.: 14/086,727

(22) Filed: Nov. 21, 2013

(30) Foreign Application Priority Data
Dec. 3, 2012 (JP) 2012-264298

(51) Int. Cl. H01M 4/48

(52) U.S. Cl. CPC H01M 4/48
USPC 429/218.1; 423/605; 423/594.15

(57) ABSTRACT

A negative electrode active substance for lithium battery is an oxide containing Re at least.

### INCORPORATION BY REFERENCE

The disclosure of Japanese Patent Application No. 2012-264298 filed on Dec. 3, 2012 including the specification, drawings and abstract is incorporated herein by reference in its entirety.

### BACKGROUND OF THE INVENTION

1. Field of the Invention

The invention relates to a negative electrode active substance containing rhenium.

2. Description of Related Art

With recent rapid prevalence of information related devices and communication devices such as PC, video camera and mobile phone, it is getting important to develop batteries utilized as their energy sources. Besides, in vehicle industry and the like, development of batteries for electric cars and hybrid cars has proceeded to achieve high output and high capacity. Among various batteries, lithium battery has currently been attracting in terms of its high energy density.

Lithium battery is generally provided with a positive electrode layer, a negative electrode layer, and an electrolyte layer formed between the positive electrode layer and the negative electrode layer. In addition, the positive electrode layer and the negative electrode layer generally contain a positive electrode active substance and a negative electrode active substance, respectively. Active substance is an important material determining battery performance, and has been studied from various aspects. For example, International Patent Application Publication No. 10/090224 discloses Li₄Ti₅O₁₂ as a negative electrode active substance. Besides, synthesize method and the result of structural analysis of NaReO₄ are disclosed in “Sodium Metaperrhenate, NaReO4: High Pressure Synthesis of Single Crystals and Structure Refinement”, Z. naturforsch. 50b. 1417-1418, 1995 by Alexandra Atzesdorferetal.

### SUMMARY OF THE INVENTION

Lithium battery is required to contain a high capacity active substance for achieving high performance. The present invention provides a high capacity negative electrode active substance.

The present inventor found that an oxide containing rhenium (Re) serves as an active substance of battery to exhibit good performance by concerted studies. The present invention is implemented in view of such viewpoints.

Namely, according to a first aspect of the present invention, the negative electrode active substance for lithium battery is an oxide containing at least Re.

According to the aspect of the present invention, with use of the oxide containing Re (rhenium), it is possible to serve the negative electrode active substance exhibiting good performance in lithium battery.

In the above aspect, the oxide may be formed of only Re and O for serving the negative electrode active substance exhibiting good capacity.

In the above aspect, the oxide may be ReO₃ for serving the negative electrode active substance exhibiting good capacity.

In the above aspect, the oxide may further contain an element or a group capable of acting as a monovalent cation, for serving the negative electrode active substance exhibiting good capacity.

In the above aspect, the above oxide may have a crystal layer represented by AReO₄, where A may be the element or the group capable of acting as the monovalent cation, for serving the negative electrode active substance exhibiting good capacity.

In a second aspect of the present invention, the lithium battery contains the positive electrode layer containing the positive electrode active substance, the negative electrode layer containing the negative electrode active substance, and the electrolyte layer formed between the above positive electrode layer and the above negative electrode layer. The above negative electrode active substance may be the negative electrode active substance mentioned above.

With the use of the negative electrode active substance mentioned above, it is possible to provide a high capacity lithium battery.

The negative electrode active substance of the present invention exhibits an advantageous effect for contributing to the growth in capacity of battery.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 shows a schematic cross-sectional view of one example of a lithium battery of the present invention;

FIG. 2 shows a result of XRD measurement for active substances used in examples 1 and 2;

FIG. 3 shows a result of charge and discharge measurement for testing battery obtained in example 1;

FIG. 4 shows a result of charge and discharge measurement for testing batteries obtained in examples 1 and 2;

FIG. 5 shows a result of XRD measurement for the active substance used in example 3; and

FIG. 6 shows a result of charge and discharge measurement for testing battery obtained in example 3.

### DETAILED DESCRIPTION OF EMBODIMENTS

Hereafter, detailed explanations are given as to a negative electrode active substance and a lithium battery according to an embodiment of the present invention.

The negative electrode active substance according to the embodiment of the present invention is a negative electrode active substance used in the lithium battery, and an oxide containing at least Re.

According to the embodiment of the present invention, with use of the oxide containing Re (rhenium), it is possible to provide a negative electrode active substance exhibiting a good capacity in the lithium battery. As exemplified by NaReO₄, the oxide containing rhenium itself is well known, but such a substance had never been known as an active substance of battery, presumably due to the difficulty in synthesis of the oxide containing rhenium and rareness of rhenium classified into a rare metal. According to the embodiment of the present invention, as described in examples given below, the oxide containing rhenium is confirmed to be a useful negative electrode active substance of lithium battery.

Besides, with the use of the oxide containing rhenium, one possible reason for serving the negative electrode active substance exhibiting superior capacity is given below. Namely, the possible reason is conversion reaction resulting from a chemical reaction between the negative electrode active substance and Li ion as well as Li insertion dissociation reaction resulting from insertion and dissociation of Li ion into the negative electrode active substance during charge and discharge. Other possible reason is that the oxide containing rhenium exhibits good capacity because of its higher electronic conductivity compared to other oxides. The oxide containing rhenium exhibits high electronic conductivity, and therefore is considered to be preferable in terms of the growth in output.

The negative electrode active substance according to the embodiment of the present invention is an oxide containing at least Re. The negative electrode active substance according to the embodiment of the present invention may be formed of only Re and O, or may be formed of Re, O and another element. The active substance containing only Re and O may be Re₂O₃, ReO₂, Re₂O₅, ReO₃, Re₂O₇ or the like, preferably ReO₂ or ReO₃, in particular ReO₃. The “active substance formed of only Re and O” defined in this application contains hydrates. Namely, the active substance formed of only Re and O contains, for example, ReO₂.2H₂O and the like.

Meanwhile, another element mentioned above is not limited to a particular one, and may be A. A is an element or a group capable of acting as a monovalent cation. A may be H, Li, Na, K, Rb, Cs, NH₄ or the like, for example, and preferably Na. The active substance composed of A, Re and O may be AReO₄, for example. Specifically, AReO₄ may be HReO₄, LiReO₄, NaReO₄, KReO₄, RbReO₄, CsReO₄, NH₄ReO₄ or the like. ReO₄⁻ having an anion structure can exhibits good capacity.

The valence number of Re of the negative electrode active substance according to the embodiment of the present invention is not limited to a particular one, but is considered to be preferably higher in terms of the growth in capacity. The possible reason is that it is possible to contribute the growth in capacity for improvement in tolerance of valence number with the use of Re having more larger valence number, although Li insertion causes the decrease in valence number of Re. The valence number of Re is preferably four or more, for example, more preferably six or more, further preferably seven or more.

The negative electrode active substance according to the embodiment of the present invention may be crystalline or amorphous. The negative electrode active substance according to the embodiment of the present invention preferably has an AReO₄ crystal phase. A refers to the same described above. NaReO₄ crystal phase generally exhibits typical peaks at 2θ=18.17°, 27.98°, 28.21°, 38.25°, 45.80° and 56.41°. The negative electrode active substance according to the embodiment of the present invention preferably includes the same crystal phase as this crystal phase or a crystal phase similar to this crystal phase. The similar crystal phase refers to a crystal phase which exhibits similar peaks at ±1°. The negative electrode active substance according to the embodiment of the present invention may include AReO₄ crystal phase as a main phase. The ratio of AReO₄ crystal phase in the negative electrode active substance can be confirmed by Rietveld analysis, for example.

The shape of the negative electrode active substance according to the embodiment of the present invention is not limited to a particular shape, and may be particle, or film or the like. When the shape of the negative electrode active substance is particle, the average particle diameter (D₅₀) is not limited to a particular one, and is in a range of 1 nm to 100 μm for example, is preferably in a range of 10 nm to 30 μm.

Next, explanations are given as to the lithium battery according to the embodiment of the present invention. The lithium battery according to the embodiment of the present invention has the positive electrode layer containing the positive electrode active substance, the negative electrode layer containing the negative electrode active substance, and the electrolyte layer formed between the positive electrode layer and the negative electrode layer, in which the negative electrode active substance is the negative electrode active substance mentioned above.

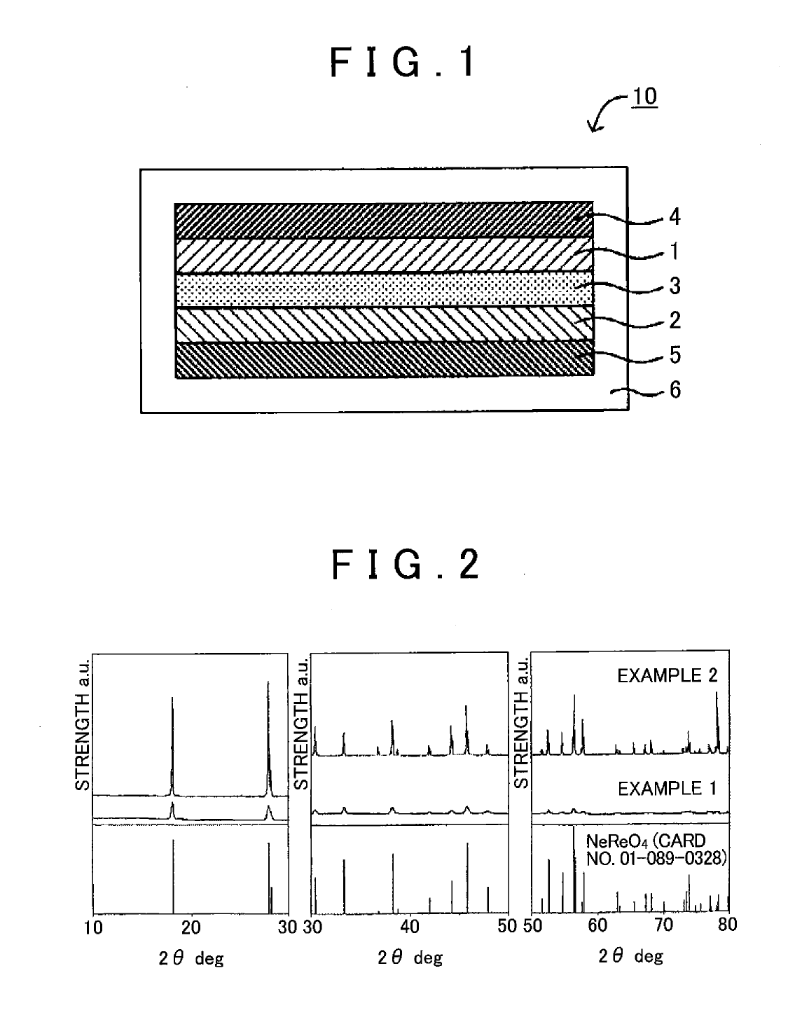

FIG. 1 shows a schematic cross-sectional view of one example of the lithium battery according to the embodiment of the present invention. The lithium battery 10 shown in FIG. 1 includes the positive electrode layer 1, the negative electrode layer 2, the electrolyte layer 3 formed between the positive electrode layer 1 and the negative electrode layer 2, a positive electrode power collector 4 for performing power collection in the positive electrode layer 1, a negative electrode power collector 5 for performing power collection in the negative electrode layer 2, and a battery case 6 accommodating therein these members. In the lithium battery according to the embodiment of the present invention, the negative electrode active substance contained in the negative electrode layer 2 is the negative electrode active substance mentioned above.

According to the embodiment of the present invention, with the use of the negative electrode active substance mentioned above, it is possible to provide a high capacity lithium battery. Hereafter, explanations are given as to the lithium battery according to the embodiment of the present invention, for each configuration.

The negative electrode layer in the embodiment of the present invention contains at least the negative electrode active substance. In addition, the negative electrode layer may contain at least one of an electrically conductive material, a binder, and a solid electrolyte material besides the negative electrode active substance. According to the embodiment of the present invention, the negative electrode active substance is the same mentioned above.

A carbon material can be given as an example of the electrically conductive material. Specifically, the carbon materials can be exemplified by acetylene black, Ketjen black, carbon black, coke, carbon fiber, graphite and the like. In addition, the binder can be exemplified by fluorine binders such as polyvinylidene fluoride (PVDF), polytetrafluoroethylene (PTFE) and rubber binders such as styrene butadiene. The solid electrolyte material can be exemplified by solid electrolyte materials described below.

The content of the negative electrode active substance in the negative electrode layer is preferably larger in terms of capacity, for example, preferably in a range of 60 wt % to 99 wt %, preferably in a range of 70 wt % to 95 wt % in particular. The content of the electrically conductive material is preferably smaller, for example within in a range of 1 wt % to 30 wt %, when assuring a predetermined electronic conductivity. The thickness of the negative electrode layer depends substantially on the configuration of the lithium battery, and preferably within a range of 0.1 μm to 1000 μm, for example.

The positive electrode layer according to the embodiment of the present invention contains at least the positive electrode active substance. In addition, the positive electrode layer may contain at least one of the electrically conductive material, the binder and the solid electrolyte material besides the positive electrode active substance. The positive electrode active substance is exemplified by rock salt layer-like active substances such as LiCoO₂, LiMnO₂, LiNiO₂, LiVO₂, LiNi_{1/3}Co_{1/3}Mn_{1/3}O₂ and the like, spinel type active substances such as LiMn₂O₄, Li(Ni_{0.5}Mn_{1.5})O₄ and olivine type active substance such as LiFePO₄, LiMnPO₄, LiNiPO₄, LiCuPO₄. The species and contents of the electrically conductive material, the binder and the solid electrolyte material used in the positive electrode layer, are the same described in the negative electrode layer.

The content of the positive electrode active substance in the positive electrode layer is preferably large in terms of capacity, for example, preferably within a range of 60 wt % to 99 wt %, more preferably within a range of 70 wt % to 95 wt %. The thickness of the positive electrode layer depends substantially on the configuration of the lithium battery, and preferably within a range of 0.1 μm to 1000 μm, for example.

According to the embodiment of the present invention, the electrolyte layer is formed between the above positive electrode layer and the above negative electrode layer. The electrolyte layer assures to perform ion conduction between the positive electrode active substance and the negative electrode active substance. The form of the electrolyte layer is not limited to a particular one, and can be exemplified by a liquid electrolyte layer, a gel electrolyte layer, a solid electrolyte layer and the like.

The liquid electrolyte layer is preferably a layer formed of a non-aqueous electrolyte liquid. The non-aqueous electrolyte liquid generally contains a lithium salt and non-aqueous solvent. The lithium salt can be exemplified by inorganic lithium salts such as LiPF₆, LiBF₄, LiClO₄, LiAsF₆ and organic lithium salts such as LiCF₃SO₃, LiN(CF₃SO₂)₂, LiN(C₂F₅SO₂)₂, LiC(CF₃SO₂)₃. The non-aqueous solvent can be exemplified by ethylenecarbonate (EC), propylenecarbonate (PC), dimethylcarbonate (DMC), diethylcarbonate (DEC), ethylmethylcarbonate (EMC), buthylenecarbonate (BC), γ-butyrolactone, sulfolane, acetonitrile, 1,2-dimethoxymethane, 1,3-dimethoxypropane, diethylether, tetrahydrofuran, 2-methyltetrahydrofuran, and a mixture thereof. The concentration of the lithium salt in the non-aqueous electrolyte liquid is within a range of 0.5 mol/L to 3 mol/L, for example.

The gel electrolyte layer can be obtained by adding a polymer into the non-aqueous electrolyte liquid and then gelation. Specifically, it is possible to add a polymer such as polyethylene oxide (PEO), polyacrylnitrile (PAN) or polymethylmethacrylate (PMMA) and the like into the non-aqueous electrolyte liquid for gelation.

The solid electrolyte layer is formed of a solid electrolyte material. The solid electrolyte material can be exemplified by oxide solid electrolyte materials and sulfide solid electrolyte materials. The oxide solid electrolyte material having Li ion conductivity can be exemplified by Li₁₊ₓAlₓGe₂₋ₓPO₄)₃ (0≦×≦2), Li₁₊ₓAlₓTi₂₋ₓ(PO₄)₃ (0≦×≦2), LiLaTiO (for example, Li_{0.34}La_{0.51}TiO₃), LiPON (for example, Li_{2.9}PO_{3.3}N_{0.46}), LiLaZrO (for example, Li₇La₃Zr₂O₁₂). The sulfide solid electrolyte material having Li ion conductivity can be exemplified by Li₂S—P₂S₅, Li₂S—SiS₂, Li₂S—GeS₂ compound and the like.

The thickness of the electrolyte layer depends substantially on the species of the electrolyte and the configuration of the lithium battery, and is preferably within a range of 0.1 μm to 1000 μm, for example, more preferably 0.1 μm to 300 μm.

The lithium battery according to the embodiment of the present invention includes at least the positive electrode layer, the negative electrode layer and the electrolyte layer which are mentioned above. In addition, the lithium battery generally includes a positive electrode power collector for power collection of the positive electrode layer and a negative electrode power collector for power collection of the negative electrode layer. Materials of the power collectors can be exemplified by SUS, aluminum, copper, nickel, iron, titan, carbon and the like. The lithium battery according to the embodiment of the present invention may include a separator between the positive electrode layer and the negative electrode layer for providing a highly safe battery.

The lithium battery according to the embodiment of the present invention may be a primary battery or a secondary battery, and preferably a secondary battery for repetitively charging and discharging and being utilized as a vehicle-loaded battery. The shape of the lithium battery according to the embodiment of the present invention can be exemplified by coin type, laminate type, tubular type, rectangular type and the like. The fabrication method of the lithium battery is not limited to a particular one, and the same as that of general lithium battery.

The embodiment of the present invention is not intended to be limited to the above embodiments. The above embodiments are illustrative, and any of which has a configuration substantially identical to the technical idea described in the claims of the present invention and exhibits the same effects, is included in the technical scope of the present invention.

Hereafter, specific explanations are given with reference to examples of the present invention.

In example 1, ReO₂.2H₂O (available from Strem chemicals, Inc., product number 75-2497) was used as an active substance. The active substance is an amorphous-like active substance not giving a peak of ReO₂ crystal phase and an active substance giving a slightly detectable peak of NaReO₄ crystal phase at XRD measurement, as described below. The active substance, a carbon material (an electrically conductive material) and PVDF (the binder) were weighed so as to achieve a weight ratio of 64:30:6 for the active substance, the carbon material and PVDF, respectively. N-methyl-2-pyrrolidone (NMP) was added as a disperser into the resultant mixture for preparation of a slurry. Next, the slurry was applied on a copper film (a power collector), then dried and rolled to provide a testing electrode.

The resultant test electrode was utilized to prepare a testing battery (coin cell). Li metal was used as an opposite electrode. LiPF₆ was dissolved into a non-aqueous electrolyte solvent which was prepared by mixing EC and DMC with EMC in volume ratio of 3:4:3 for EC, DMC and EMC, respectively, achieving a concentration of 1 mol/dm³. A PP/PE/PP laminate typed macroporous film was utilized as a separator. The testing battery was obtained in this way.

In example 2, the testing battery was obtained in the same way as in example 1, except that NaReO₄ (available from Strem chemicals, Inc., product number 93-7508) was used as an active substance.

The active substances in examples 1 and 2 were subjected to XRD measurement (utilizing CuKα ray). FIG. 2 shows the result. As shown in FIG. 2, the active substance in example 1 is an amorphous-like active substance not giving peaks of ReO₂ crystal phase, and is an active substance giving slightly detectable peaks of NaReO₄ crystal phase. Meanwhile, the peaks of NaReO₄ crystal phase were detected for the active substance in example 2. The NaReO₄ crystal phase generally gives typical peaks at 2θ=18.17°, 27.98°, 28.21°, 38.25°, 45.80° and 56.41°.

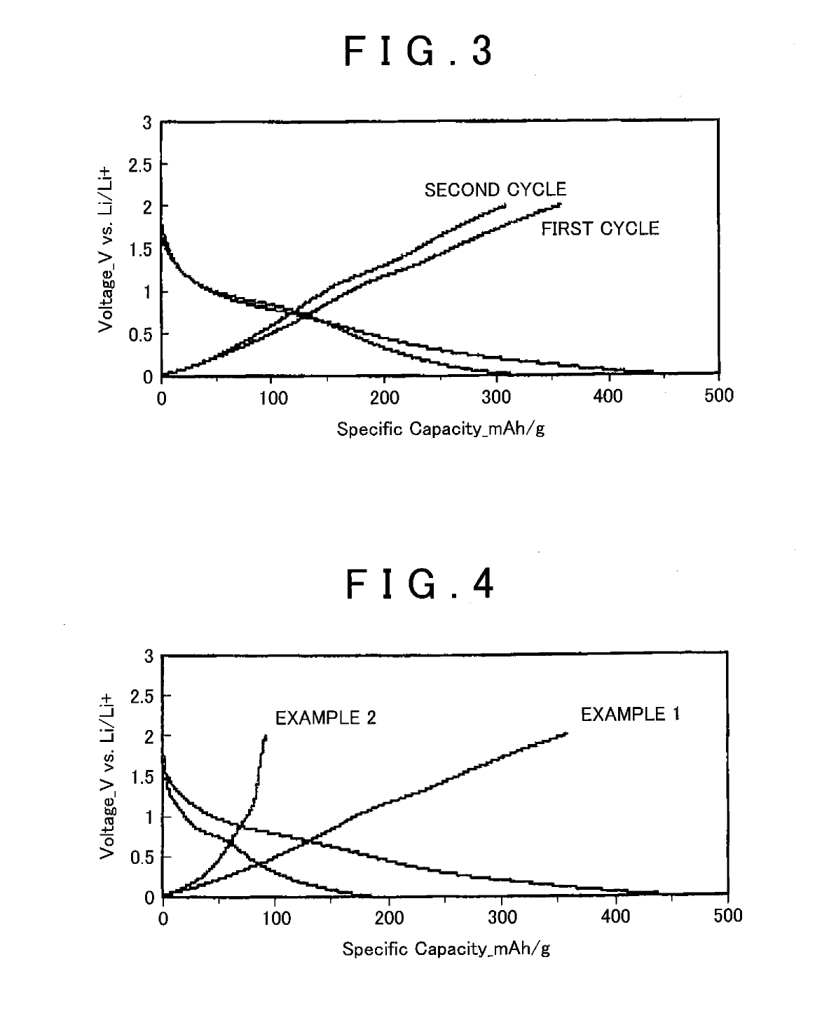

First, charge and discharge test was conducted for the testing battery obtained in example 1. The constant current charge and discharge test was conducted under a load current of 26 mA/g (active substance), in a voltage range of 0.05V-2.0V under 25° C. FIG. 3 and Table 1 show the result.

TABLE 1

| | Charging capacity | Discharge capacity | Efficiency |
|---|---|---|---|
| | (mAh/g) | (mAh/g) | (%) |
| First cycle | 443.7 | 356.5 | 80.3 |
| Second cycle | 313.0 | 308.3 | 98.5 |

As shown in FIG. 3 and Table 1, the testing battery obtained in example 1 was confirmed to serve as a battery with high capacity. According to charge and discharge curve, the testing battery can cause charge and discharge reaction also outside of plateau portion, indicating the possibility of conversion reaction as well as Li insertion dissociation reaction.

Next, the same test was conducted for the testing battery obtained in example 2. FIG. 4 shows the result. As shown in FIG. 4, the testing battery obtained in example 2 was also confirmed to serve as a battery with a superior capacity. According to charge and discharge curve, the testing battery can cause charge and discharge reaction also outside of plateau portion, indicating the possibility of conversion reaction as well as Li insertion dissociation reaction.

In example 3, the testing battery was obtained in the same way as in example 1, except that ReO₃ (available from Strem chemicals, Inc., product number 75-2500) was used as an active substance.

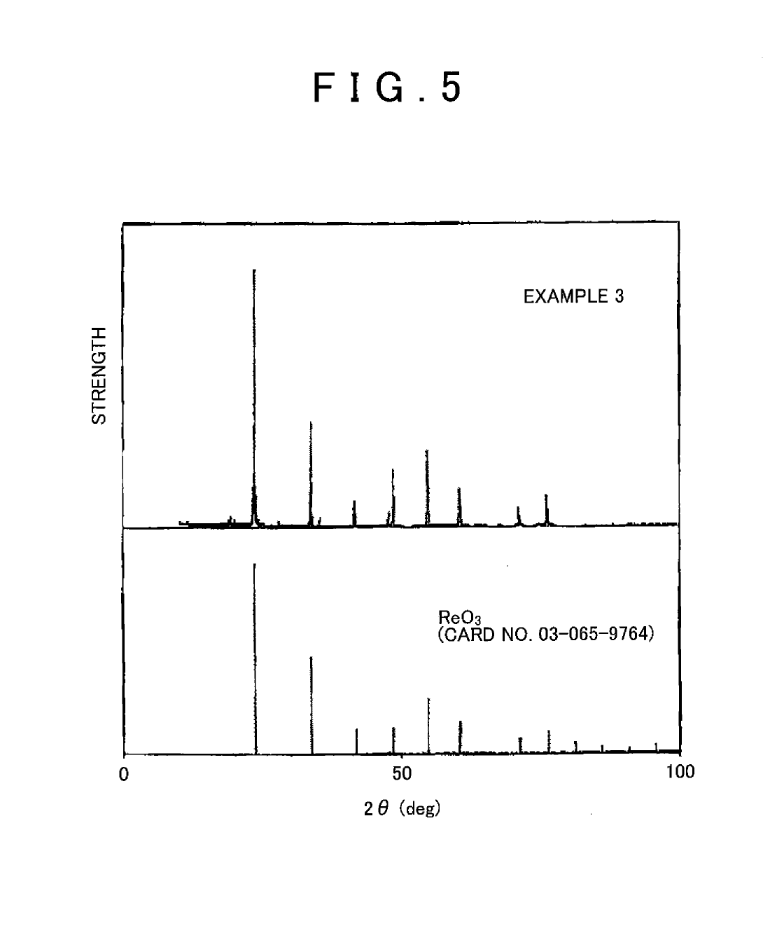

XRD measurement (utilizing CuKα ray) was conducted for the active substance in example 3. FIG. 5 shows the result. As shown in FIG. 5, peaks of ReO₃ crystal phase were detected for the active substance in example 3. The ReO₃ crystal phase generally gives typical peaks at 2θ=23.74°, 33.84°, 54.76°, 60.51° and 76.23°. In addition, according to XRD measurement, the active substance in example 3 may contain impurities slightly.

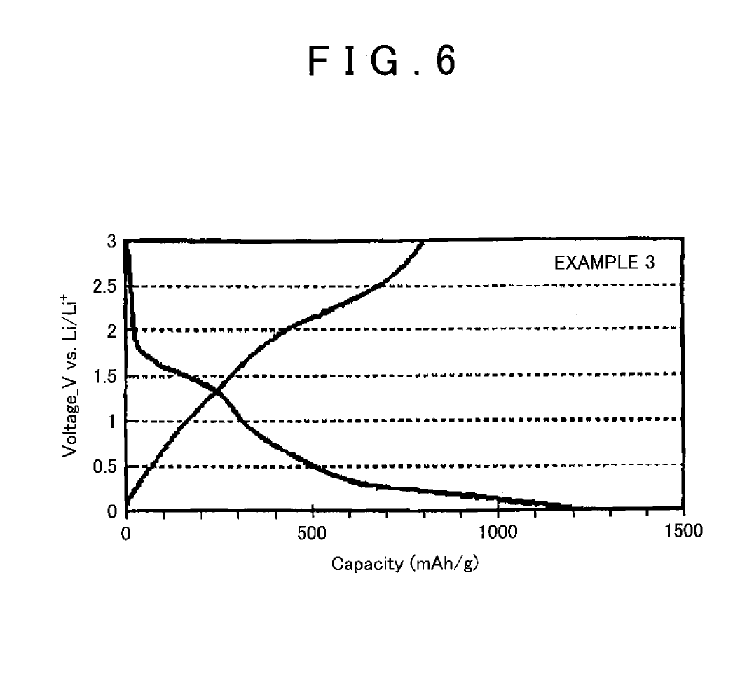

The same charge and discharge test was conducted for the testing battery obtained in example 3. FIG. 6 and Table 2 show the result.

TABLE 2

| | Charging capacity | Discharge capacity | Efficiency |
|---|---|---|---|
| | (mAh/g) | (mAh/g) | (%) |
| First cycle | 1224.8 | 799.1 | 65.2 |

As shown in FIG. 6 and Table 2, the testing battery obtained in example 3 was also confirmed to serve as a battery with an extremely high capacity. According to charge and discharge curve, the testing battery can cause charge and discharge reaction also outside of plateau portion, indicating the possibility of conversion reaction as well as Li insertion dissociation reaction.

What is claimed is:

1. A negative electrode active substance for a lithium battery, wherein the negative electrode active substance is an oxide containing Re at least.

2. The negative electrode active substance according to claim 1, wherein the oxide is composed of only Re and O.

3. The negative electrode active substance according to claim 2, wherein the oxide is ReO₃.

4. The negative electrode active substance according to claim 1, wherein the oxide further contains an element or a group capable of serving as a monovalent cation.

5. The negative electrode active substance according to claim 4, wherein the oxide has an AReO₄ crystal phase, where A is the element or the group capable of serving as the monovalent cation.

6. Lithium battery comprising:
a positive electrode layer containing a positive electrode active substance;
a negative electrode layer containing a negative electrode active substance; and
an electrolyte layer disposed between the positive electrode layer and the negative electrode layer,
wherein the negative electrode active substance is an oxide containing Re at least.
